(19) United States
(12) Patent Application Publication
(10) Pub. No.: US 2026/0136083 A1
(43) Pub. Date: May 14, 2026

(54) Camera Module and Preparing Method Thereof and Electronic Device

(71) Applicant: NINGBO SUNNY OPOTECH CO., LTD, Yuyao City (CN)

(72) Inventors: Guoquan Hu, Yuyao City (CN); Qianjin Cao, Yuyao City (CN); Kai Chen, Yuyao City (CN); Peng Lu, Yuyao City (CN); Shi Xiong, Yuyao City (CN); Jiawei Chen, Yuyao City (CN); Weijie Jiang, Yuyao City (CN); Hua Fu, Yuyao City (CN)

(21) Appl. No.: 19/286,257

(22) Filed: Jul. 31, 2025

(30) Foreign Application Priority Data
Nov. 14, 2024 (CN) 2024116212973

(51) Int. Cl. H04N 23/54; H04N 23/55; H04N 23/68

(52) U.S. Cl. CPC H04N 23/54; H04N 23/55; H04N 23/682

(57) ABSTRACT

A camera module includes a first circuit board, a photosensitive chip electrically connected to the first circuit board, a base comprising a first part located on a back of the first circuit board to support the first circuit board and a second part at least partially located on a periphery of the first part and protruded upward from the first part, a movable part mounted on the second part, and a lens assembly arranged on the movable part so as to be movably constrained in a photosensitive path of the photosensitive chip. The second part is at least partially lower than the first circuit board.

### CROSS REFERENCE OF RELATED APPLICATION

This application is a non-provisional application that claims priority under 35U.S.C. § 119 to China application number CN 202411621297.3, filing date Nov. 14, 2024, wherein the entire content of which is expressly incorporated herein by reference.

### BACKGROUND OF THE PRESENT INVENTION

### Field of Invention

The present invention relates to the field of imaging technology, and more particular to a camera module, a preparing method thereof and an electronic device.

### Description of Related Arts

With the advancement and development of science and technology, electronic devices with camera functions are increasingly moving towards high performance and lightweight. As one of the core components of electronic products, the camera module must be adaptively adjusted in terms of performance and size. In other words, in this round of technological innovation, each component in the camera module needs to make corresponding changes in performance and size.

As an indispensable component of a high-pixel camera module, the motor is used to drive the lens to move in multiple directions during the operation of the camera module, so as to realize the optical autofocus function (hereinafter referred to as AF function;) and optical image stabilization function (hereinafter referred to as OIS function) during shooting.

However, the conventional camera module is usually assembled together with a relatively independent motor and photosensitive assembly that is, the conventional camera module usually fixes a motor base to an optical filter holder of the photosensitive assembly and the optical filter holder is usually installed above the circuit board of the photosensitive assembly resulting in a large shoulder height of the camera module, which is difficult to meet the miniaturization requirements of the camera module.

### SUMMARY OF THE PRESENT INVENTION

An advantage of the present application is that it provides a camera module, a preparing method thereof and an electronic device which can effectively reduce the shoulder height of the camera module and meet the miniaturization requirements of the camera module.

In order to achieve at least one of the above advantages or other advantages and purposes of the present invention, the present invention provides a camera module, comprising
a first circuit board;
a photosensitive chip electrically connected to the first circuit board;
a base comprising a first part located on a back of the first circuit board to support the first circuit board and a second part at least partially located on a periphery of the first part and protruded upward from the first part;
a movable part mounted on the second part; and
a lens assembly arranged on the movable part so as to be movably constrained in a photosensitive path of the photosensitive chip.

With such a configuration, the base of the present application can not only support and reinforce the first circuit board through the first part, so that the first circuit board is not easy to bend, so that the electrical connection between the photosensitive chip and the first circuit board is not easy to fail, which helps to improve the reliability of the camera module; but also the base can serve as the mounting base of the movable part of a motor unit through the second part, so that the integration of components in the camera module is higher, and there is no need to process the mounting base of the first circuit board and the mounting base of the movable part separately and then assemble them together, so as to reduce the assembly process. More importantly, the mounting base of the motor unit in the present application is at least partially lower than the first circuit board, and is designed to be sunken compared with the mounting base of the motor unit in the prior art, thereby effectively reducing the shoulder height of the module to meet the miniaturization requirements of the camera module.

According to one embodiment of the present application, the camera module further comprises a first coil and a magnetic member relatively located above the first coil; the second part comprises a first mounting portion, the first coil is arranged on the first mounting portion and is electrically connected to the first circuit board, and the magnetic member is arranged on the movable part.

In this way, the base of the present application can serve as a supporting carrier for the first coil to generate a stable Lorentz force with the magnetic member when the first coil is energized, so as to drive the movable part to drive the lens assembly to move with respect to the photosensitive chip, thereby achieving the desired anti-shake function.

According to one embodiment of the present application, the second part comprises a first mounting portion; the camera module further comprises a second circuit board installed on the first mounting portion, wherein the second circuit board is located between the movable part and the first circuit board in a direction of an optical axis, and the second circuit board is provided with a second through hole corresponding to the photosensitive chip; wherein the second circuit board is electrically connected to the first circuit board, and the first coil is installed on the second circuit board.

With such a configuration, the present application can achieve electrical connection between the first coil and the first circuit board through the second circuit board, ensuring more convenient processing and assembly.

According to one embodiment of the present application, the base has an accommodating space and a notch communicated to the accommodating space, and the notch is located on a first side of the base; wherein a connector is provided on a portion of the first circuit board that passes through the notch and extends out of the accommodating space, and the first mounting portion avoids the first side of the base.

With such an arrangement, on one hand, the present application arranges the connector of the first circuit board outside the accommodating space, so as to facilitate the electrical connection between the connector and the external power supply structure, thereby facilitating the power supply to the camera module; on the other hand, the present application allows the first mounting portion to avoid the side where the connector is located, and can reasonably arrange the first mounting portion and the notch on the peripheral side of the base, which can make the camera module structure more compact and facilitate the miniaturization of the camera module.

According to one embodiment of the present application, the first mounting portion comprises at least two first sub-portions arranged at intervals along the circumferential direction; the second circuit board comprises at least two side portions, at least one of which is connected to the first sub-portion on the corresponding side and is provided with the first coil.

With such a configuration, the first mounting portion of the present application can support the side of the second circuit board through the first sub-portion, so that the side is not easily warped, deformed or bent, ensuring that the electrical connection between the first coil and the second circuit board is not easily failed.

According to an embodiment of the present application, the second circuit board further comprises a connecting portion located within the accommodating space, the connecting portion connects the bottoms of two adjacent side portions, and is located below the movable part.

With such a configuration, the connection portion of the present application is located within the accommodation space and below the movable part, so that the connection part can be designed as a limit structure for the movable part and/or the lens assembly to move downward, and the space between the two adjacent side portions and the space outside thereof can be reserved in the inner and outer directions to facilitate the spatial arrangement of other components of the camera module, which helps to reduce the lateral size of the camera module. In addition, the present application connects the connection portion to the bottom of the two adjacent side portions, which can reserve more space above the connection portion to design the travel path of the movable part in the direction of the optical axis, which helps to reduce the shoulder height of the module.

According to one embodiment of the present application, the second part further comprises at least three second mounting portions arranged at intervals along the circumferential direction, and the camera module further comprises a suspension assembly arranged between the movable part and the second mounting portion, wherein the notch is formed between a pair of adjacent second mounting portions, and the first sub-portion is provided between other adjacent second mounting portions.

In this way, the present application provides the first sub-portion between adjacent second mounting portions for supporting the suspension assembly, which not only makes the support point of the suspension component in the second part and the mounting position of the first coil in the second part spaced circumferentially, but also makes the support point of the suspension assembly in the second part and the mounting position of the first coil in the second part more dispersed in the circumferential direction, ensuring that the driving force driving the movable part to move and the suspension force applied to the movable part are more balanced, which helps to reduce assembly tilt.

According to an embodiment of the present application, the first mounting portion and the second mounting portion are connected, and the second mounting portion is located outside the connecting portion of the second circuit board.

With such a configuration, the present application designs the second mounting portion to be located outside the connecting portion, so that the connecting portion and the second mounting portion can be reasonably arranged in the inner and outer directions, which is beneficial to reducing the lateral size of the camera module.

According to one embodiment of the present application, a side portion of the second circuit board is located at the notch and is provided with pins, and the pins are electrically connected to the first circuit board; the first part comprises a main body that together with the second part defines the accommodating space and an extension portion extended from the main body to the outside of the notch.

With such arrangement, the present application can not only shorten the circuit design path by arranging pins electrically connected to the first circuit board on the side portion located at the notch; but also by arranging the extension portion located outside the notch on the first part, the first part can better support the electrical connection between the second circuit board and the first circuit board, thereby ensuring that the first circuit board is not prone to bending or breaking, and ensuring that the electrical connection between the pins of the second circuit board and the first circuit board is not prone to failure.

According to one embodiment of the present application, the base further comprises a first electrical conductive member embedded in the first mounting portion and electrically connected to the first circuit board; wherein the first coil is mounted on the first mounting portion, and the first coil is electrically connected to the first electrical conductive member.

With such a configuration, the camera module of the present application can omit the second circuit board, and directly electrically connect the first coil with the first circuit board through the first electrical conductive member embedded in the first mounting portion, thereby saving the space occupied by the second circuit board and further reducing the size of the camera module.

According to one embodiment of the present application, the second part comprises a second mounting portion that is higher than the first mounting portion; wherein the camera module further comprises a suspension assembly arranged between the movable part and the second mounting portion.

With such a configuration, the present application can allow for a reasonable design of the height difference between the second mounting portion and the first mounting portion through the design of the height position relationship between the second mounting portion and the first mounting portion, and can reserve sufficient accommodation space for the magnetic member while avoiding the camera module from being too large in size.

According to one embodiment of the present application, the second mounting portion comprises a second sub-portion, the movable portion comprises an anti-shake bracket constrained to the second part in a manner that allows the anti-shake bracket to move in a direction perpendicular to the optical axis, and the lens assembly is constrained to the anti-shake bracket; the suspension assembly comprises a ball bearing constrained between the anti-shake bracket and the second sub-portion.

According to one embodiment of the present application, there are multiple second sub-portions, and they are distributed at intervals along the circumferential direction; each of the second sub-portions is provided with a first strip groove, and the multiple first strip grooves are rotationally symmetrically distributed with respect to the optical axis of the lens assembly; the anti-shake bracket is provided with multiple second strip grooves that correspond one-to-one to the first strip grooves and extend in directions perpendicular to each other, and each of the second strip grooves and the corresponding first strip groove together form a ball cavity for accommodating the ball bearing.

With such a configuration, the ball bearing of the present application can support the anti-shake bracket while allowing the anti-shake bracket to move in a direction perpendicular to the optical axis, so as to achieve the desired anti-shake function.

According to one embodiment of the present application, the second mounting portion further comprises a third sub-portion, and the third sub-portion is at least partially located at a corner of the second part. The suspension assembly comprises a first spring element, and the first spring element comprises a first section whose two ends are constrained between the anti-shake bracket and the third sub-portion.

With such a configuration, the present application uses the first spring element to provide damping and elastic force for the movement of the anti-shake bracket during resetting, which can make the anti-shake movement and resetting of the anti-shake bracket more stable; at the same time, the size design of the first spring element between the anti-shake bracket and the third sub-portion affects the anti-shake stroke. Since the length at the diagonal is larger, the present application arranges at least a part of the third sub-portion at the corner of the second section, so that the camera module has enough space to arrange the part of the first spring element between the anti-shake bracket and the third sub-portion, that is, it can allow more space to be reserved for designing the anti-shake stroke, which is conducive to the miniaturization of the camera module.

According to one embodiment of the present application, the movable part further comprises a focusing bracket constrained to the anti-shake bracket in a manner that the focusing bracket can move along the optical axis, and the lens assembly is constrained to the focusing bracket; the first spring element further comprises a second section whose two ends are constrained between the focusing bracket and the anti-shake bracket; the magnetic member is arranged on the anti-shake bracket, and the camera module further comprises a second coil arranged on the focusing bracket and opposite to the magnetic member; the base further comprises a second electrical conductive member embedded in the third sub-part and electrically connected to the first circuit board, the first spring element is a metal part that electrically conducts the second electrical conductive member and the second coil.

With such a configuration, the present application uses the first spring element to provide damping and elastic force for resetting the movement of the focusing bracket, and through the design of embedding the second electrical conductive member into the third sub-portion, the focusing bracket can be electrically connected to the first circuit board through the first spring element and the second electrical conductive member, so as to power the electromagnetic drive mechanism of the focusing bracket and simplify the motor circuit design; at the same time, the present application can simplify the design of the motor drive mechanism through the design of the first coil and the second coil sharing the magnetic member, which contributes to the miniaturization of the camera module.

According to one embodiment of the present application, the second mounting portion comprises a second sub-portion and a third sub-portion protruded upward from the second sub-portion, and the suspension assembly comprises a first suspension member and a second suspension member, the first suspension member is arranged between the second sub-portion and a lower portion of the movable part, and the second suspension member is arranged between the third sub-portion and an upper portion of the movable part.

With such an arrangement, the suspension assembly of the present application can constrain the movable part from the upper and lower parts respectively, so that the force on the movable part is more balanced, so as to suspend the movable part more stably and the movable part is not prone to assembly tilt.

According to an embodiment of the present application, the base is a molded body formed on the first circuit board.

According to one embodiment of the present application, the first part is provided with an accommodating hole, and the first circuit board is provided with a first through hole corresponding to the photosensitive chip; the photosensitive chip is located in the accommodating hole and is flipped on the first circuit board.

With such a configuration, the present application mounts the photosensitive chip on the back side of the first circuit board so that the back focal length of the camera module partially overlaps with the base, thereby being able to reduce the module shoulder height.

According to one embodiment of the present application, the camera module further comprises an optical filter element which is installed on a front side of the first circuit board to cover the first through hole.

With such arrangement, the present application eliminates the need for a optical filter holder by directly mounting the optical filter element on the front side of the first circuit board, thereby further reducing the module shoulder height.

According to one embodiment of the present application, the camera module further comprises a lens barrel constrained by the movable part, and the lens assembly is installed inside the lens barrel; the optical filter element is rectangular, and a long side of the optical filter element is at least partially located inside the lens barrel; wherein an electronic component installation area is provided on the front side of the first circuit board, and the electronic component installation area is located between the long side of the optical filter element and an inner edge of the lens barrel.

In this way, the present application can reduce the size of the optical filter element by locating at least part of the long side of the optical filter element inside the lens barrel, so that the optical filter element is not easy to crack. In addition, the electronic component installation area is arranged on the front side of the first circuit board, which can reduce the magnetic interference with the photosensitive chip; the electronic component installation area is arranged between the long side of the optical filter element and the inner edge of the lens barrel, and the space between the long side of the optical filter element and the inner edge of the lens barrel can be reasonably used to arrange electronic components, thereby allowing the distance between the short side of the optical filter element and the corresponding side of the camera module to be shortened, which helps to reduce the width of the camera module.

According to another aspect of the present application, the present application further provides an electronic device, comprising:
a device body, and
any one of the camera modules described above, wherein the camera module is assembled on the device body.

According to another aspect of the present application, the present application further provides a method for preparing a camera module, comprising the steps of:
placing a second electrical conductive member in a cavity of a first injection mold to injection mold a third sub-portion embedded with the second electrical conductive member;
placing the first circuit board and a plurality of third sub-portions in a cavity of the second injection mold, so as to form a base by injection molding a portion of the second part excluding the third sub-portions and the first part, wherein the first part is located at a back of the first circuit board to support the first circuit board and comprises a main body and an extension portion, and the second part is protruded upward from the first part and is located at a periphery of the main body;
flip-mounting the photosensitive chip on the first circuit board; and
mounting the movable part with the lens assembly on the second part of the base to obtain a camera module.

With such a configuration, the present application uses a secondary injection molding method to form the base, which can allow a sufficient height difference to be designed between the third sub-portions and the portion of the base excluding the third sub-portion. This is because when the height difference between the third sub-portions and the portion of the base excluding the third sub-portion is large, using a one-time injection molding method to mold the base is prone to poor molding during injection molding.

### BRIEF DESCRIPTION OF THE DRAWINGS

FIG. 1 is a perspective view of a camera module according to an embodiment of the present application;

FIG. 2 is an exploded view of the camera module according to the above embodiment of the present application;

FIG. 3A is a sectional view of the camera module according to the above embodiment of the present application;

FIG. 3B is another sectional view of the camera module according to the above embodiment of the present application;

FIG. 4 shows an example of the camera module without a housing according to the above embodiment of the present application;

FIG. 5 is a sectional view of the camera module according to the above example of the present application;

FIG. 6 is a schematic view illustrating a photosensitive assembly of the camera module according to the above example of the present application;

FIG. 7 is a schematic view illustrating a camera module according to an alternative mode of the above embodiment of the present application;

FIG. 8 is a schematic flow chart illustrating a preparing method of the camera module according to an embodiment of the present application.

In the drawings: 1, camera module; 11, first circuit board; 1101, first through hole; 1102, electronic component installation area; 111, rigid board part; 112, flexible board part; 113, connector; 12, photosensitive chip; 121, photosensitive area; 122, non-photosensitive area; 13, Base; 13a, first side; 130, molded body; 1301, accommodating space; 1302, notch; 131, first part; 1310, accommodating hole; 1311, main body; 1312, extension portion; 132, second part; 1321, first mounting portion; 13210, first sub-portion; 1322, second mounting portion; 13220, first strip groove; 13221, second sub-portion; 13222, third sub-part; 133, first electrical conductive member; 134, second electrical conductive member; 14, movable part; 141, focusing bracket; 142, anti-shake bracket; 1420, second strip groove; 15, optical lens; 151, lens assembly; 152, lens barrel; 16, suspension assembly; 161, first spring element; 1611, first section; 1612, second section; 162, ball bearing; 163, second spring element; 17, electromagnetic drive mechanism; 171, first coil; 172, magnetic member; 173, second coil; 18, second circuit board; 180, second through hole; 181, side portion; 1811, transverse area; 1812, first longitudinal area; 1813, second longitudinal area; 1814, pin; 182, connecting portion; 19, reinforcing plate; 20, optical filter element; 21, housing.

The above description of the reference numerals of the main component is combined with the accompanying drawings and specific implementation methods to further illustrate the present invention in detail.

### DETAILED DESCRIPTION OF THE PREFERRED EMBODIMENT

The following will be combined with the drawings in the embodiments of the present invention to clearly and completely describe the technical solutions in the embodiments of the present invention. Obviously, the described embodiments are only part of the embodiments of the present invention, not all of the embodiments. Based on the embodiments of the present invention, all other embodiments obtained by ordinary technicians in this field without creative work are within the scope of protection of the present invention.

It should be noted that when a component is described as being “mounted on” another component, it may be mounted directly on that component or indirectly via an intermediate component. When a component is described as being “provided on” another component, it may be directly disposed thereon or indirectly through an intermediate component. Similarly, when a component is described as being “fixed to” another component, it may be directly fixed or fixed via one or more intermediate components.

Unless otherwise defined, all technical and scientific terms used herein have the same meaning as those commonly understood by those skilled in the art to which the present invention belongs. The terms used herein in the specification of the present invention are only for the purpose of describing specific embodiments and are not intended to limit the present invention. The term “or/and” used herein comprises any and all combinations of one or more of the related listed items.

Considering that the conventional camera module fixes the motor base to the optical filter bracket of the photosensitive assembly the shoulder height of the camera module is still relatively large, which makes it difficult to meet the miniaturization requirements of the camera module. Therefore, the present application proposes a camera module and a preparation method thereof and an electronic device, which can effectively reduce the module shoulder height to meet the miniaturization requirements of the camera module.

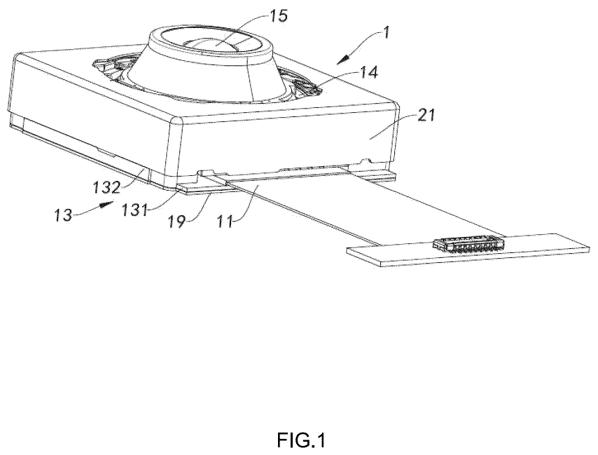

Specifically, referring to FIGS. 1 to 3, an embodiment of the present application provides an electronic device which may comprise a device body and a camera module 1 mounted on the device body, so as to collect image information for the device body through the camera module 1. It is understood that the electronic device mentioned in the present application may be implemented as, but not limited to, a smart phone, a smart watch, a tablet or a notebook.

More specifically, as shown in FIGS. 1 to 7, the camera module 1 comprises a first circuit board 11, a photosensitive chip 12, a base 13, a movable part 14, and an optical lens 15. The photosensitive chip 12 is electrically connected to the first circuit board 11. The base 13 comprises a first part 131 located on a back of the first circuit board 11 to support the first circuit board 11, and a second part 132 located at least partially on a periphery of the first part 131 and protruding upward from the first part 131. The movable part 14 is mounted on the second part 132, and the optical lens 15 is arranged on the movable part 14 to be movably constrained in the photosensitive path of the photosensitive chip 12, ensuring that external light first passes through the optical lens 15 and is then received by the photosensitive chip 12 for imaging.

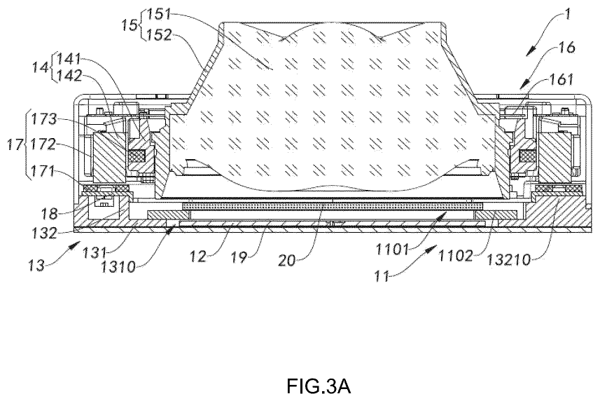

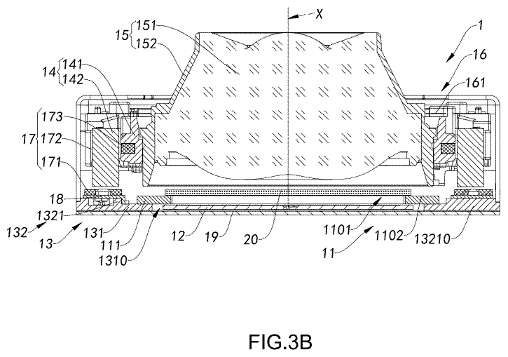

It is worth noting that the base 13 mentioned in the present application can not only support and reinforce the first circuit board 11 through the first part 131, so that the first circuit board 11 is not easy to bend, so that the electrical connection between the photosensitive chip 12 and the first circuit board 11 is not easy to fail, which helps to improve the reliability of the camera module 1; but also the base 13 can serve as the mounting base of the movable part 14 of the motor through the second part 132, so that the integration of the components in the camera module 1 is higher, and there is no need to process the mounting base of the first circuit board 11 and the mounting base of the movable part 14 separately and then assemble them together, so as to reduce the assembly process. The conventional IR filter holder is also omitted. By positioning the second part 132 at a position surrounding the first circuit board 11, the entire movable part including the magnet and coil, is relocated downward. As a result, the height of the ancillary components disposed on either side is correspondingly lowered, thereby reducing the overall shoulder height of the camera module. The second part 132 used as the motor mounting base in the present application is at least partially lower than the first circuit board 11, and is designed to be sunken compared with the motor mounting base in the prior art, thereby effectively reducing the shoulder height of the module, so as to meet the miniaturization requirements of the camera module 1. Particularly, as shown in FIG. 3B, the second part 132 comprises a first mounting portion 1321 and a second mounting portion 1322, a top surface of the first mounting portion 1321 can be lower than a top surface of the first circuit board 11.

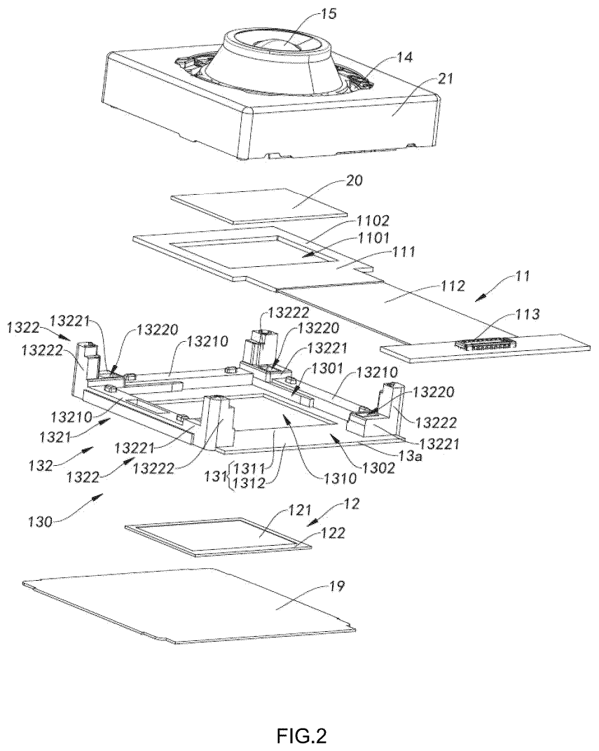

In addition, as shown in FIG. 2, the base 13 mentioned in the present application may have an accommodating space 1301 and a notch 1302 communicating with the accommodating space 1301, and the notch 1302 is located at the first side 13a of the base 13. A connector 113 is provided on the first circuit board 11 at a portion of the notch 1302 that passes through the accommodating space 1301.

In an example of the present application, as shown in FIG. 2, the first part 131 may comprise a main body 1311 and an extension portion 1312, wherein the main body 1311 and the second part 132 together form an accommodating space 1301 and a notch 1302, wherein the notch 1302 is communicated to the accommodating space 1301 and is located at the first side 13a of the base 13. The extension portion 1312 is located outside the accommodating space 1301 and corresponds to the first side 13a of the base 13. Accordingly, the first circuit board 11 may comprise a rigid board part 111, a flexible board part 112, and a connector 113, wherein the rigid board part 111 is extended out of the accommodating space 1301 from the notch 1302; the flexible board part 112 is connected to a side of the rigid board part 111 extending out of the accommodating space 1301, and the connector 113 is disposed on the flexible board part 112 to facilitate electrical connection with an external power supply structure. In particular, the back side of the rigid board part 111 is attached to the first part 131, so that the first part 131 supports and reinforces the rigid board part 111, ensuring that the rigid board part 111 is not easily bent, so that the electrical connection between the photosensitive chip 12 and the rigid board part 111 is not easily failed, thereby improving the reliability of the camera module.

In an example of the present application, as shown in FIG. 2 and FIGS. 3A to 3B, the main body 1311 of the first part 131 may be provided with an accommodating hole 1310, and the rigid board part 111 of the first circuit board 11 is provided with a first through hole 1101 corresponding to the photosensitive chip 12; the photosensitive chip 12 is located in the accommodating hole 1310 and is flipped on the first circuit board 11. The photosensitive chip 12 has a photosensitive area 121 corresponding to the first through hole 1101 and a non-photosensitive area 122 located around the photosensitive area 121, and the non-photosensitive area 122 of the photosensitive chip 12 is fixedly connected to the first circuit board 11. It can be understood that “the first through hole 1101 corresponds to the photosensitive chip 12” means that the light emitted from the optical lens 15 can be irradiated to the photosensitive area 121 of the photosensitive chip 12 through the first through hole 1101. In other words, the camera module 1 of the present application can overlap the space of the first part 131 and the space of the photosensitive chip 12 in the direction of the optical axis X by accommodating the photosensitive chip 12 in the accommodating hole 1310 and flipping it on the first circuit board 11, so that the back focal length of the camera module 1 partially overlaps with the base 13, thereby reducing the shoulder height of the module.

It is worth noting that in other embodiments of the present application, the photosensitive chip can be installed on the front side of the first circuit board 11 or in the first through hole 1101 of the first circuit board 11. The photosensitive chip 12 and the first circuit board 12 can also be electrically connected by wire bonding.

In addition, as shown in FIG. 3A, the camera module 1 may further comprise an electromagnetic drive mechanism 17 for driving the movable part 14 to drive the optical lens 15 to move with respect to the photosensitive chip 12, thereby realizing the focusing and/or anti-shake function of the camera module 1.

As an example, as shown in FIG. 3A, the electromagnetic drive mechanism 17 of the camera module 1 may comprise a first coil 171 and a magnetic member 172 located above the first coil 171; the first coil 171 is disposed on the second part 132 and is electrically connected to the first circuit board 11, and the magnetic member 172 is disposed on the movable part 14. In this way, the base 13 of the present application can serve as a support carrier for the first coil 171 to generate a stable Lorentz force with the magnetic member 172 when the first coil 171 is energized, so as to drive the movable part 14 to drive the optical lens 15 to move with respect to the photosensitive chip 12, thereby achieving the desired anti-shake function.

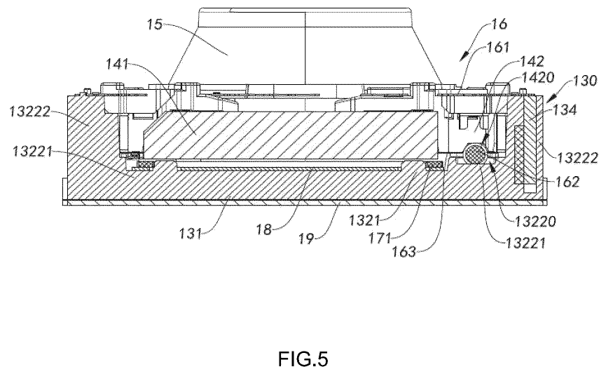

Optionally, as shown in FIG. 3A, FIG. 3B and FIG. 5, the movable part 14 comprises an anti-shake bracket 142, and the anti-shake bracket 142 is constrained to the second part 132 in a manner that the anti-shake bracket 142 can move in a direction perpendicular to the optical axis X, and the optical lens 15 is constrained to the anti-shake bracket 142. At this time, the magnetic member 172 is arranged on the anti-shake bracket 142 and arranged corresponding to the first coil 171, so that when the first coil 171 is energized, it generates a Lorentz force with the magnetic member 172, driving the anti-shake bracket 142 to drive the optical lens 15 to move in a direction perpendicular to the optical axis X, thereby realizing the anti-shake function of the camera module 1. It can be understood that in other examples of the present application, the installation positions of the first coil 171 and the magnetic member 172 can be interchanged, and the desired anti-shake function can still be realized, and the present application will not repeat this; in addition, the optical axis X mentioned in the present application refers to the optical axis X of the optical lens 15.

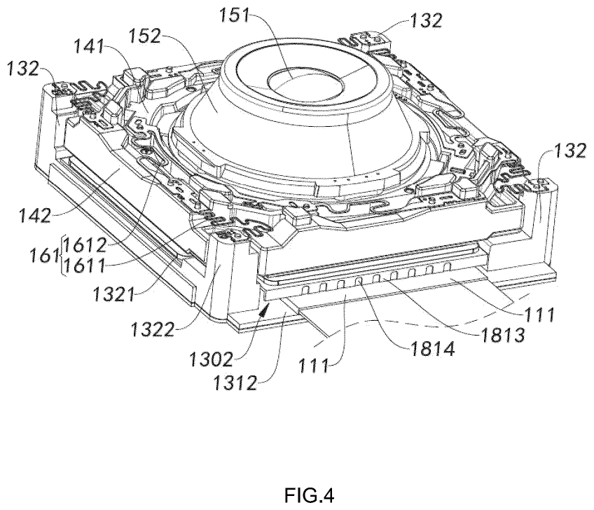

Optionally, as shown in FIGS. 3A to 4, the movable part 14 further comprises a focusing bracket 141, the focusing bracket 141 is constrained to the anti-shake bracket 142 in a manner that the focusing bracket 141 can move along the optical axis X, and the optical lens 15 is mounted on the focusing bracket 141. At this time, the electromagnetic drive mechanism 17 may further comprise a second coil 173 disposed on the focusing bracket 141 and opposite to the magnetic member 172, the second coil 173 is electrically connected to the first circuit board 11, so as to generate a Lorentz force with the magnetic member 172 when the second coil 173 is energized, so as to drive the focusing bracket 141 to drive the optical lens 15 to move along the optical axis X, thereby realizing the focusing function of the camera module 1.

It is worth noting that in the above example of the present application, as shown in FIG. 3, the first coil 171 and the second coil 173 can share the same magnetic member 172, which can not only generate a Lorentz force with the magnetic member 172 after the first coil 171 is energized, and is used to drive the anti-shake bracket 142 to drive the optical lens 15 to move in a direction perpendicular to the optical axis X to achieve optical image stabilization, but also can generate a Lorentz force with the magnetic member 172 after the second coil 173 is energized, and is used to drive the focusing bracket 141 to drive the optical lens 15 to move in the opposite direction along the optical axis X to achieve automatic focus. It can be understood that in other examples of the present application, the movable part 14 may not comprise the focusing bracket 141, but realize the required focusing function by moving the photosensitive chip 12, wherein the autofocus driving mechanism of the photosensitive chip 12 can be referred to the prior art; in addition, the installation positions of the second coil 173 and the magnetic member 172 mentioned in the present application can also be interchanged, and the present application will not repeat the description.

According to the above mentioned embodiments of the present application, as shown in FIGS. 2 to 6, the second part 132 may comprise a first mounting portion 1321; the camera module 1 further comprises a second circuit board 18 mounted on the first mounting portion 1321. The second circuit board 18 is located between the movable part 14 and the first circuit board 11 in the direction of the optical axis X, and the second circuit board 18 is provided with a second through hole 180 corresponding to the photosensitive chip 12. The second circuit board 18 is electrically connected to the first circuit board 11, and the first coil 171 is mounted on the second circuit board 18. In this way, the camera module 1 of the present application can realize the electrical connection between the first coil 171 and the first circuit board 11 through the second circuit board 18, ensuring that the processing and assembly are more convenient. It can be understood that the “second through hole 180 corresponding to the photosensitive chip 12” mentioned in the present application means that the second through hole 180 allows the light emitted from the optical lens 15 to be irradiated to the photosensitive area 121 of the photosensitive chip 12 through the second through hole 180; there is no limitation on the positional relationship between the optical lens 15 and the second through hole 180, and the optical lens 15 can be located above the second circuit board 18, or the optical lens 15 can be passed through the second through hole 180.

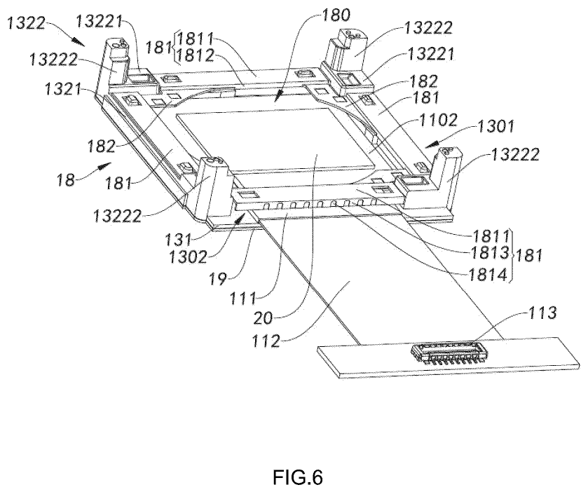

Optionally, as shown in FIG. 2 and FIG. 6, the first mounting portion 1321 avoids the first side 13a of the base 13. In this way, the first mounting portion 1321 can avoid the side where the connector 113 is located, and the first mounting portion 1321 and the notch 1302 can be reasonably arranged on the peripheral side of the base 13, which can make the structure of the camera module 1 more compact and facilitate the miniaturization of the camera module 1.

It is worth noting that the first mounting portion 1321 comprises at least two first sub-portions 13210 arranged at intervals along the circumferential direction; the second circuit board 18 comprises at least two side portions 181, wherein at least one of the side portions 181 is connected to the first sub-portion 13210 on the corresponding side and is provided with the first coil 171. For example, as shown in FIG. 2 and FIG. 3, the first mounting portion 1321 may comprise three first sub-portions 13210 arranged at intervals along the circumferential direction; the second circuit board 18 may comprise four side portions 181 each of which may be provided with the first coil 171, wherein three side portions 181 are connected to the first sub-portion 13210 on the corresponding side. In this way, the first mounting portion 1321 of the present application can support the side portions 181 of the second circuit board 18 through the first sub-portions 13210, so that the side portions 181 are not prone to warping, deformation or bending, and ensures that the electrical connection between the first coil 171 and the second circuit board 18 is not prone to failure.

Optionally, as shown in FIG. 6, the second circuit board 18 further comprises a connecting portion 182 located within the accommodating space 1301, the connecting portion 182 connects the bottoms of the two adjacent side portions 181, and is located below the movable part 14. In this way, the connecting portion 182 of the present application is within the accommodating space 1301 and is located below the movable part 14, so that the connecting portion 182 can be designed as a limiting structure for the movable part 14 and/or the optical lens 15 to move downward, and can also reserve the space between the two adjacent side portions 181 and the outer space in the inner and outer directions, so as to facilitate the spatial arrangement of other components of the camera module 1, which helps to reduce the lateral size of the camera module 1. In addition, the present application connects the connecting portion 182 to the bottoms of the two adjacent side portions 181, which can reserve more space above the connecting portion 182 to design the travel path of the movable part 14 in the optical axis direction, which helps to reduce the module shoulder height.

As an example, as shown in FIG. 6, the second circuit board 18 has four side portions 181, and the two ends of the connecting portion 182 are respectively fixedly connected to two adjacent side portions 181 to jointly define the second through hole 180 located at the periphery of the optical lens 15, so that the second circuit board 18 can limit the movement of the movable part 14 in the direction of the optical axis X while allowing the optical lens 15 to be as close to the photosensitive chip 12 as possible to reduce the overall height of the module.

Optionally, as shown in FIG. 6, each side portion 181 may have a transverse area 1811 fixedly connected to the upper surface of the first sub-portion 13210 and a first longitudinal area 1812 extending downward from the inner edge of the transverse area 1811, and the connecting portion 182 is extended inward from a lower edge of the first longitudinal area 1812; the first coil 171 is correspondingly installed in the transverse area 1811 of the side portion 181.

Optionally, as shown in FIGS. 3A, 3B and 6, a side portion 181 of the second circuit board 18 is located at the notch 1302 and is provided with pins 1814, and the pins 1814 are electrically connected to the first circuit board 11. In other words, the side portion 181 of the second circuit board 18 corresponding to the notch 1302 may have a second longitudinal area 1813 extended downward from the outer edge of the transverse area 1811 and pins 1814 provided in the second longitudinal area 1813, so that the second circuit board 18 is electrically connected to the first circuit board 11 through the pins 1814.

According to the above mentioned embodiment of the present application, as shown in FIGS. 2, 5 and 6, the second part 132 further comprises at least three second mounting portions 1322 arranged at intervals along the circumferential direction, and the camera module 1 further comprises a suspension assembly 16 arranged between the movable part 14 and the second mounting portion 1322, wherein the notch 1302 is formed between a pair of adjacent second mounting portions 1322, and the first sub-portion 13210 is provided between other adjacent second mounting portions 1322. In this way, the present application provides the first sub-portion 13210 between adjacent second mounting sections 1322 to support the suspension component 16, which not only makes the support point of the suspension component 16 in the second part 132 and the mounting position of the first coil 171 in the second part 132 spaced circumferentially, but also makes the support point of the suspension component 16 in the second part 132 and the mounting position of the first coil 171 in the second part 132 more dispersed in the circumferential direction, ensuring that the driving force driving the movable part 14 to move and the suspension force applied to the movable part 14 are more balanced, which helps to reduce assembly tilt.

Optionally, as shown in FIG. 2 and FIG. 6, the first mounting portion 1321 is connected to the second mounting portion 1322, and the second mounting portion 1322 is located outside the connecting portion 182 of the second circuit board 18. In this way, the second mounting portion 1322 is designed to be located outside the connecting portion 182, and the connecting portion 182 and the second mounting portion 1322 can be reasonably arranged in the inner and outer directions, which is conducive to reducing the lateral size of the camera module 1.

Optionally, as shown in FIG. 2 and FIG. 3B, the first mounting portion 1321 is lower than the second mounting portion 1322, and the suspension assembly 16 is connected between the movable part 14 and the second mounting portion 1322. In this way, the present application can allow for a reasonable design of the height difference between the second mounting portion 1322 and the first mounting portion 1321 through the design of the height position relationship between the second mounting portion 1322 and the first mounting portion 1321, and can reserve sufficient accommodation space 1301 for the magnetic member 172 while avoiding the camera module 1 from being too large in size.

It is worth noting that, as shown in FIG. 2, FIG. 5 and FIG. 6, the second mounting portion 1322 may comprise a second sub-portion 13221 and a third sub-portion 13222 protruded upward from the second sub-portion 13221; accordingly, the suspension assembly 16 may comprise a first suspension member and a second suspension member, the first suspension member being disposed between the second sub-portion 13221 and the lower portion of the movable part 14, and the second suspension member being disposed between the third sub-portion 13222 and the upper portion of the movable part 14. In this way, the suspension assembly 16 of the present application can be constrained from the upper and lower portions of the movable part 14 respectively, so as to more stably suspend the movable part 14. It can be understood that the first suspension member mentioned in the present application can be but not limited to being implemented as a ball bearing162; the second suspension member mentioned in the present application can be but not limited to being implemented as a first spring element 161; of course, in other examples of the present application, the suspension component 16 can also be implemented as a guide column or a wire, etc., as long as the desired suspension effect can be achieved, and the present application will not go into details.

As an example, as shown in FIG. 5, the second mounting portion 1322 comprises a second sub-portion 13221, the movable part 14 comprises an anti-shake bracket 142 constrained to the second part 132 in a manner that allows the anti-shake bracket 142 to move in a direction perpendicular to the optical axis X, and the optical lens 15 is constrained to the anti-shake bracket 142; the suspension assembly 16 comprises a ball bearing 162 constrained between the anti-shake bracket 142 and the second sub-portion 13221.

Optically, as shown in FIG. 2, FIG. 5 and FIG. 6, the second mounting portion 1322 comprises a plurality of second sub-portions 13221 spaced apart along the circumferential direction; each second sub-portion 13221 is provided with a first strip groove 13220, and the plurality of first strip grooves 13220 are rotationally symmetrically distributed with respect to the optical axis X of the optical lens 15; the anti-shake bracket 142 is provided with a plurality of second strip grooves 1420 corresponding to the first strip grooves 13220 one by one and extending in directions perpendicular to each other, and each second strip groove 1420 and the corresponding first strip groove 13220 together form a ball cavity for accommodating the ball bearing 162. In this way, the ball bearing 162 of the present application can support the anti-shake bracket 142 while allowing the anti-shake bracket 142 to move in a direction perpendicular to the optical axis X, so as to achieve the desired anti-shake function.

Optionally, as shown in FIGS. 2, 4, and 5, the second mounting portion 1322 further comprises a plurality of third sub-portions 13222; the third sub-portions 13222 are at least partially located at the corners of the second part 132, and the suspension assembly 16 comprises a first spring element 161 which comprises a first section 1611 whose two ends are constrained between the anti-shake bracket 142 and the third sub-portion 13222. In this way, the present application uses the first spring element 161 to provide damping and elastic force during resetting for the movement of the anti-shake bracket 142, which can make the anti-shake movement and resetting of the anti-shake bracket 142 more stable; at the same time, the size design of the first spring element 161 between the anti-shake bracket 142 and the third sub-portion 13222 affects the anti-shake stroke. Since the length at the diagonal is larger, the present application arranges at least a part of the third sub-portion 13222 at the corner of the second part 132, so that the camera module 1 has enough space to arrange the first spring element 161 between the anti-shake bracket 142 and the third sub-portion 13222, that is, it can allow more space to be reserved for designing the anti-shake stroke, which is conducive to the miniaturization of the camera module 1.

Optionally, as shown in FIGS. 3A to 4, the movable part 14 further comprises a focusing bracket 141 constrained to the anti-shake bracket 142 in a manner that the focusing bracket 141 can move along the optical axis X, and the optical lens 15 is constrained to the focusing bracket 141; the first spring element 161 further comprises a second section 1612 whose two ends are constrained between the focusing bracket 141 and the anti-shake bracket 142; the magnetic member 172 is arranged on the anti-shake bracket 142, and the camera module 1 further comprises a second coil 173 arranged on the focusing bracket 141 and opposite to the magnetic member 172; the base 13 further comprises a second electrical conductive member 134 embedded in the third sub-portion 13222 and electrically connected to the first circuit board 11, the first spring element 161 is a metal member, and electrically conducts the second electrical conductive member 134 and the second coil 173. In this way, the present application uses the first spring element 161 to provide damping and elastic force for resetting the movement of the focusing bracket 141, and the design of embedding the second electrical conductive member 134 into the third sub-portion 13222 enables the focusing bracket 141 to achieve electrical conduction with the first circuit board 11 through the first spring element 161 and the second electrical conductive member 134, which can power the electromagnetic drive mechanism of the focusing bracket 141 and simplify the motor circuit design; at the same time, the present application can simplify the design of the motor drive mechanism through the design of the first coil 171 and the second coil 173 sharing the magnetic member 172, which helps to miniaturize the camera module 1.

It is worth noting that, as shown in FIG. 4 and FIG. 5, the two ends of the first spring element 161 are respectively fixedly connected to the upper part of the third sub-portion 13222 and the upper part of the focusing bracket 141, so as to be implemented as an upper elastic piece constrained from the upper part of the movable part 14. At the same time, as shown in FIG. 4, a middle part of the first spring element 161 is fixedly connected to the upper part of the anti-shake bracket 142, so that the anti-shake bracket 142 is constrained from the upper and lower sides of the movable part 14 by the first spring element 161 and the ball bearing 162.

In addition, as shown in FIG. 5, the suspension assembly 16 of the present application may further comprise a second spring element 163, the two ends of the second spring element 163 are respectively fixedly connected to the lower part of the focusing bracket 141 and the lower part of the anti-shake bracket 142, so that the focusing bracket 141 can be constrained from the upper and lower sides of the movable part 14 by the first spring element 161 and the second spring element 163.

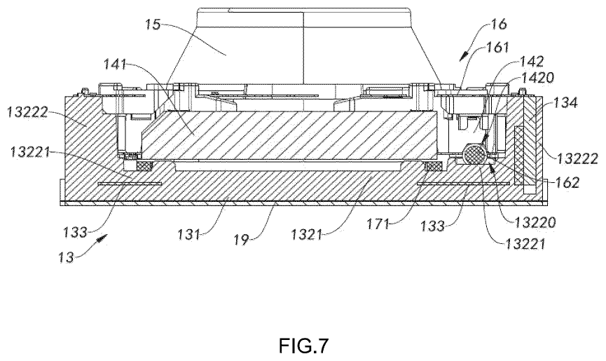

It is worth mentioning that in a modified example of the present application, as shown in FIG. 7, the camera module 1 may not comprise the second circuit board 18; in this case, the base 13 further comprises a first electrical conductive member 133 embedded in the first mounting portion 1321 and electrically connected to the first circuit board 11; wherein the first coil 171 is mounted on the first mounting portion 1321, and the first coil 171 is electrically connected to the first electrical conductive member 133. In this way, the camera module 1 of the present application directly electrically connects the first coil 171 to the first circuit board 11 through the first electrical conductive member 133 embedded in the first mounting portion 1321, without the need to additionally set up the second circuit board 18, thereby saving the space occupied by the second circuit board 18, so as to further reduce the size of the camera module 1.

According to the above mentioned embodiment of the present application, as shown in FIG. 2, FIG. 3A, FIG. 3B and FIG. 6, the camera module 1 further comprises an optical filter element 20 which can be an IR filter, and the optical filter element 20 is installed on the front side of the first circuit board 11 to cover the first through hole 1101. In this way, the camera module 1 of the present application directly installs the optical filter element 20 on the front side of the first circuit board 11 so as to omit the optical filter holder, which is conducive to further reducing the module shoulder height. It is understandable that the optical filter element 20 mentioned in the present application can be mounted on the front side of the first circuit board 11.

Optionally, as shown in FIGS. 1 to 7, the camera module 1 further comprises a reinforcing plate 19 which is mounted on the first part 131 to seal the accommodating hole 1310, thereby preventing the back side of the photosensitive chip 12 from being exposed, so as to protect the photosensitive chip 12 and reduce external impact on the photosensitive chip 12.

Optionally, as shown in FIG. 3A, there is a gap between the upper surface of the reinforcing plate 19 and the back of the photosensitive chip 12, ensuring that when the camera module 1 is impacted on its back, the reinforcing plate 19 will not contact the photosensitive chip 12, thereby preventing the impact on the reinforcing plate 19 from being transmitted to the photosensitive chip 12.

It is worth noting that a buffer glue can be filled between the reinforcing plate 19 and the photosensitive chip 12, so that the buffer glue can absorb the impact on the back of the photosensitive chip 12, protect the photosensitive chip 12, and make it not easily damaged. It can be understood that the present application can make the photosensitive component of the camera module 1 both thin and light and the photosensitive chip 12 not easily damaged by reasonably designing the distance between the reinforcing plate 19 and the photosensitive chip 12.

In addition, a glue can be filled between the peripheral side wall of the photosensitive chip 12 and the first part 131. The glue can be a glue with a large elastic modulus, such as DA glue, which can reinforce the connection between the photosensitive chip 12, the first part 131 and the reinforcing plate 19 to improve the reliability of the connection; or, the glue can also be glue with a small elastic modulus, such as buffer glue, which can convert mechanical energy into thermal energy, thereby eliminating the impact effect and achieving stress buffering for the photosensitive chip 12.

Optionally, as shown in FIGS. 1 to 3A, the camera module 1 further comprises a housing 21, which is covered on the second part 132 to cover the movable part 14. It is understandable that the housing 21 can be implemented as a metal housing to play the role of a magnetic yoke.

Optionally, as shown in FIGS. 3S to 4, the optical lens 15 in the camera module 1 may comprise a lens assembly 151 and a lens barrel 152 constrained to the movable part 14, and the lens assembly 151 is installed in the lens barrel 152. Specifically, the lens barrel 152 may be installed on the focusing bracket 141 to achieve the installation of the optical lens 15 on the focusing bracket 141; a lens mounting hole is provided inside the lens barrel 152, and the lens assembly 151 is installed in the lens mounting hole.

More specifically, as shown in FIG. 3A, the optical filter element 20 may be rectangular, and the long side of the optical filter element 20 is at least partially located inside the lens barrel 152; wherein the front surface of the first circuit board 11 is provided with an electronic component installation area 1102, and the electronic component installation area 1102 is located between the long side of the optical filter element 20 and the inner edge of the lens barrel 152. In this way, the present application can reduce the size of the optical filter element 20 by locating at least a part of the long side of the optical filter element 20 inside the lens barrel 152, so that the optical filter element 20 is not easy to crack. In addition, the electronic component mounting area 1102 is arranged on the front side of the first circuit board 11, which can reduce magnetic interference with the photosensitive chip 12; the electronic component mounting area 1102 is arranged between the long side of the optical filter element 20 and the inner edge of the lens barrel 152, and can reasonably utilize the space between the long side of the optical filter element 20 and the inner edge of the lens barrel 152 to arrange electronic components, thereby allowing the distance between the short side of the optical filter element 20 and the corresponding side of the camera module 1 to be shortened, which helps to reduce the width of the camera module 1.

It is understandable that in other examples of the present application, the optical lens 15 may also only comprise the lens assembly 151, and the focusing bracket 141 is provided with a lens mounting hole, and the lens assembly 151 is directly installed in the lens mounting hole of the focusing bracket 141, and this application will not go into details.

It is worth mentioning that according to the above mentioned embodiment of the present application, as shown in FIGS. 2 and 5, the base 13 can be but is not limited to being implemented as a molded body 130 formed on the first circuit board 11, which can be prepared by a single injection molding process or a secondary injection molding process.

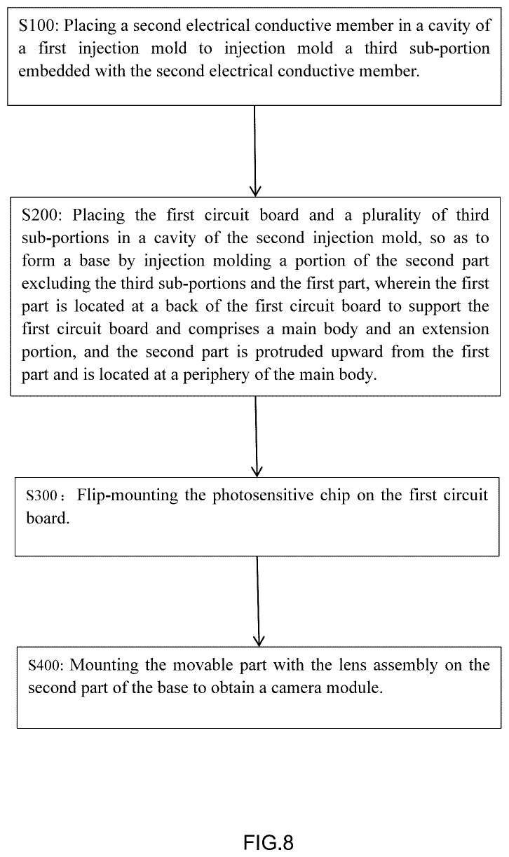

Specifically, according to another aspect of the present application, as shown in FIG. 8, an embodiment of the present application further provides a method for preparing a camera module, which may comprise the steps of:
S100: placing a second electrical conductive member in a cavity of a first injection mold to injection mold a third sub-portion embedded with the second electrical conductive member;
S200: placing a first circuit board and a plurality of third sub-parts in a cavity of a second injection mold, and injection molding a portion of the second part excluding the third sub-parts and the first part to form a base, wherein the first part is located on the back of the first circuit board to support the first circuit board and comprises a main body and an extension portion, and the second part protrudes upward from the first part and is located at the periphery of the main body;
S300: flip-mounting the photosensitive chip on the first circuit board; and
S400: installing the movable part with the lens assembly on the second part of the base to obtain a camera module.

It is worth noting that if the base 13 is prepared by a one-time single injection molding process, poor molding may easily occur during injection molding due to the large height difference between different parts of the base 13; therefore, the preparation method of the present application preferably uses a secondary injection molding process to mold the base 13, which can allow the third sub-portion 13222 and the part of the base 13 other than the third sub-portion 13222 to be designed with a sufficient height difference, that is: first, the third sub-portion 13222 with a larger height is injection molded for the first time, and then the other parts of the base 13 are injection molded for the second time on the first circuit board 11 and the third sub-portion 13222, to ensure that the base 13 is well molded.

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The above embodiments only express several implementation methods of the present invention, and the descriptions thereof are relatively specific and detailed, but they cannot be understood as limiting the scope of the invention patent. It should be pointed out that, for ordinary technicians in this field, several variations and improvements can be made without departing from the concept of the present invention, and these all belong to the protection scope of the present invention.

What is claimed is:

1. A camera module, comprising
a first circuit board;
a photosensitive chip electrically connected to the first circuit board;
a base comprising a first part located on a back of the first circuit board to support the first circuit board and a second part at least partially located on a periphery of the first part and protruded upward from the first part, wherein the second part is at least partially lower than the first circuit board;
a movable part mounted on the second part; and
a lens assembly arranged on the movable part so as to be movably constrained in a photosensitive path of the photosensitive chip.

2. The camera module according to claim 1, wherein the camera module further comprises a first coil and a magnetic member relatively located above the first coil; the second part comprises a first mounting portion, the first coil is arranged on the first mounting portion and is electrically connected to the first circuit board, and the magnetic member is arranged on the movable part.

3. The camera module according to claim 2, wherein the camera module further comprises a second circuit board installed on the first mounting portion, wherein the second circuit board is located between the movable part and the first circuit board in a direction of an optical axis, and the second circuit board is provided with a second through hole corresponding to the photosensitive chip; wherein the second circuit board is electrically connected to the first circuit board, and the first coil is installed on the second circuit board.

4. The camera module according to claim 3, wherein the base has an accommodating space and a notch communicated to the accommodating space, and the notch is located on a first side of the base; wherein a connector is provided on a portion of the first circuit board that passes through the notch and extends out of the accommodating space, and the first mounting portion avoids the first side of the base.

5. The camera module according to claim 4, wherein the first mounting portion comprises at least two first sub-portions arranged at intervals along a circumferential direction; the second circuit board comprises at least two side portions, at least one of the at least two side portions is connected to the first sub-portion on the corresponding side and is provided with the first coil.

6. The camera module according to claim 5, wherein the second circuit board further comprises a connecting portion located within the accommodating space, the connecting portion connects bottoms of two adjacent side portions, and is located below the movable part.

7. The camera module according to claim 6, wherein the second part further comprises at least three second mounting portions arranged at intervals along the circumferential direction, and the camera module further comprises a suspension assembly arranged between the movable part and the second mounting portion, wherein the notch is formed between a pair of adjacent second mounting portions, and each first sub-portion is provided between other adjacent second mounting portions.

8. The camera module according to claim 7, wherein the first mounting portion and the second mounting portion are connected, and the second mounting portion is located outside the connecting portion of the second circuit board.

9. The camera module according to claim 5, wherein a side portion of the second circuit board is located at the notch and is provided with pins which are electrically connected to the first circuit board; the first part comprises a main body that together with the second part defines the accommodating space and an extension portion extended from the main body to the outside of the notch.

10. The camera module according to claim 2, wherein the base further comprises a first electrical conductive member embedded in the first mounting portion and electrically connected to the first circuit board; wherein the first coil is mounted on the first mounting portion, and the first coil is electrically connected to the first electrical conductive member.

11. The camera module according to claim 2, wherein the second part comprises a second mounting portion that is higher than the first mounting portion; wherein the camera module further comprises a suspension assembly arranged between the movable part and the second mounting portion.

12. The camera module according to claim 11, wherein the second mounting portion comprises a second sub-portion, the movable portion comprises an anti-shake bracket constrained to the second part in a manner that allows the anti-shake bracket to move in a direction perpendicular to an optical axis, and the lens assembly is constrained to the anti-shake bracket; the suspension assembly comprises a ball bearing constrained between the anti-shake bracket and the second sub-portion.

13. The camera module according to claim 12, wherein the second mounting portion comprises multiple second sub-portions which are distributed at intervals along a circumferential direction; each of the second sub-portions is provided with a first strip groove, and the multiple first strip grooves are rotationally symmetrically distributed with respect to the optical axis of the lens assembly; the anti-shake bracket is provided with multiple second strip grooves that correspond one-to-one to the first strip grooves and extend in directions perpendicular to each other, and each of the second strip grooves and the corresponding first strip groove together form a ball cavity for accommodating the ball bearing.

14. The camera module according to claim 12, wherein the second mounting portion further comprises a third sub-portion which is at least partially located at a corner of the second part, wherein the suspension assembly comprises a first spring element, and the first spring element comprises a first section whose two ends are constrained between the anti-shake bracket and the third sub-portion.

15. The camera module according to claim 14, wherein the movable part further comprises a focusing bracket constrained to the anti-shake bracket in a manner that the focusing bracket is capable of moving along the optical axis, and the lens assembly is constrained to the focusing bracket; the first spring element further comprises a second section whose two ends are constrained between the focusing bracket and the anti-shake bracket; the magnetic member is arranged on the anti-shake bracket, and the camera module further comprises a second coil arranged on the focusing bracket and opposite to the magnetic member; the base further comprises a second electrical conductive member embedded in the third sub-part and electrically connected to the first circuit board, the first spring element is a metal part that electrically conducts the second electrical conductive member and the second coil.

16. The camera module according to claim 11, wherein the second mounting portion comprises a second sub-portion and a third sub-portion protruded upward from the second sub-portion, and the suspension assembly comprises a first suspension member and a second suspension member, the first suspension member is arranged between the second sub-portion and a lower portion of the movable part, and the second suspension member is arranged between the third sub-portion and an upper portion of the movable part.

17. The camera module according to claim 1, wherein the base is a molded body formed on the first circuit board.

18. The camera module according to claim 1, wherein the first part is provided with an accommodating hole, and the first circuit board is provided with a first through hole corresponding to the photosensitive chip; the photosensitive chip is located in the accommodating hole and is flipped on the first circuit board.

19. The camera module according to claim 18, wherein the camera module further comprises an optical filter element which is installed on a front side of the first circuit board to cover the first through hole.

20. The camera module according to claim 19, wherein the camera module further comprises a lens barrel constrained by the movable part, and the lens assembly is installed inside the lens barrel; the optical filter element is rectangular, and a long side of the optical filter element is at least partially located inside the lens barrel; wherein an electronic component installation area is provided on the front side of the first circuit board, and the electronic component installation area is located between the long side of the optical filter element and an inner edge of the lens barrel.
